(19) United States
(12) Patent Application Publication
(10) Pub. No.: US 2022/0148079 A1
(43) Pub. Date: May 12, 2022

(54) SETTLEMENT SYSTEM AND SETTLEMENT METHOD

(71) Applicant: HITACHI, LTD., Tokyo (JP)

(72) Inventors: Yusuke JIN, Tokyo (JP); Nishio YAMADA, Tokyo (JP); Yasunori HASHIMOTO, Tokyo (JP)

(73) Assignee: HITACHI, LTD., Tokyo (JP)

(21) Appl. No.: 17/422,949

(22) PCT Filed: Feb. 21, 2020
(86) PCT No.: PCT/JP2020/007098

§ 371 Date: Jul. 14, 2021

(30) Foreign Application Priority Data
Mar. 5, 2019 (JP) 2019-039676

(51) Int. Cl. G06Q 40/02; G06Q 20/10; G06Q 20/38; G06Q 30/02

(52) U.S. Cl. CPC G06Q 40/025; G06Q 20/102; G06Q 2220/00; G06Q 30/0207; G06Q 20/3825

(57) ABSTRACT

A settlement system having a settlement requesting device that has a processor and a memory; a settlement execution device that has a processor and a memory; and an electronic credit management device that manages electronic credits or debts, wherein the settlement requesting device issues a payment request in accordance with an electronic settlement medium, and the settlement execution device accepts the payment request in accordance with the settlement medium, causes the electronic credit management device to record the occurrence of a debt in accordance with the payment request, and transmits the settlement medium to a receiver.

### INCORPORATION BY REFERENCE

The present application asserts the priority of Japanese Patent Application No. 2019-039676 which is a Japanese application filed on 5 Mar. 2019 (2019), and incorporates the content thereof by reference.

### TECHNICAL FIELD

The present invention relates to an electronic settlement system.

### BACKGROUND ART

The digitalization of finance and commercial transactions is progressing. An electronic credit management system that digitalizes credit such as a note that a company owns is known as a technology for improving the liquidity of credit (for example, Patent Document 1).

In this electronic credit management system, a credit occurs by recording an electronic credit (electronic credit) in a recording ledger managed by an electronic credit recording institution, and the movement of capital (monetary credit) such as by assignment is managed. A paying company (debtor) hands over an electronic credit to a delivering company (creditor), and records the occurrence of the debt in the electronic credit management system. On the payment due date of the electronic credit, a financial institution that participates in the electronic credit management system transfers capital from the account of the paying company to the account of the delivering company.

In addition, in the electronic credit management system, it is possible to assign or discount a credit similarly to with a conventional note, and the liquidity of capital is ensured.

### PRIOR ART DOCUMENT

### Patent Document

Patent Document 1: JP-2013-12144-A

### SUMMARY OF THE INVENTION

### Problems to be Solved by the Invention

However, the conventional example described above is premised on all paying companies and delivering companies having joined the electronic credit management system. There is a problem that a delivering company that has not joined the electronic credit management system cannot use the electronic credit.

In addition, in a community such as a supply chain, it is possible to perform settlement by an electronic settlement medium such as a virtual currency, but there is a problem that a virtual currency has no guarantee for value because the virtual currency has no relation to legal tender, and using the virtual currency is difficult.

Accordingly, the present invention is made in light of the problems described above, and an objective of the present invention is to realize electronic settlement that guarantees the value of an electronic settlement medium even in the case where there is a user who does not participate in an existing settlement system.

### Means for Solving the Problems

The present invention is a settlement system having a settlement requesting device that has a processor and a memory; a settlement execution device that has a processor and a memory; and an electronic credit management device that manages electronic credits or debts, in which the settlement requesting device issues a payment request in accordance with an electronic settlement medium, and the settlement execution device accepts the payment request in accordance with the settlement medium, causes the electronic credit management device to record the occurrence of a debt in accordance with the payment request, and transmits the settlement medium to a receiver.

### Advantages of the Invention

Accordingly, by issuing a settlement medium (for example, a token) in a community that includes a settlement requesting device and a settlement execution device to thereby realize circulation of credit, and making links with an existing settlement system (an electronic credit management device), the present invention can ensure the value of the settlement medium. In the present invention, it is possible to realize settlement after guaranteeing the value of an electronic settlement medium (a token), even with a community in which there is a company (operator) that does not participate in an existing settlement system.

Details of at least one implementation of the subject matter disclosed in the present specification are described with reference to the attached drawings and in the description below. Other features, aspects, and effects of the disclosed subject matter will become apparent from the following description, the drawings, and the claims.

### BRIEF DESCRIPTION OF THE DRAWINGS

FIG. 1 is a block view that illustrates a first embodiment of the present invention and illustrates an example of a device configuration for a settlement system.

FIG. 2 is a view that illustrates the first embodiment of the present invention, and illustrates an example of a token community that uses the settlement system, and relationships between companies and financial institutions.

FIG. 3 is a block view that illustrates the first embodiment of the present invention and illustrates an example of a community settlement requesting device.

FIG. 4 is a block view that illustrates the first embodiment of the present invention and illustrates an example of a community settlement execution device.

FIG. 5 is a flow chart that illustrates the first embodiment of the present invention, and illustrates an example of a token issuance process which is performed by the community settlement execution device.

FIG. 6 is a flow chart that illustrates the first embodiment of the present invention, and illustrates an example of a token payment request process which is performed by the community settlement requesting device.

FIG. 7 is a flow chart that illustrates the first embodiment of the present invention, and illustrates an example of a token payment acceptance process which is performed by the community settlement execution device.

FIG. 8 is a flow chart that illustrates the first embodiment of the present invention, and illustrates an example of a token liquidation request process which is performed by the community settlement requesting device.

FIG. 9 is a flow chart that illustrates the first embodiment of the present invention, and illustrates an example of a token liquidation acceptance process which is performed by the community settlement execution device.

FIG. 10 is a view that illustrates the first embodiment of the present invention, and illustrates an example of an account management table.

FIG. 11 is a view that illustrates the first embodiment of the present invention, and illustrates an example of a community management table.

FIG. 12 is a view that illustrates the first embodiment of the present invention, and illustrates an example of a token balance management table.

FIG. 13 is a view that illustrates the first embodiment of the present invention, and illustrates an example of a distributed token ledger.

FIG. 14 is a view that illustrates the first embodiment of the present invention, and illustrates an example of an electronic credit management table.

FIG. 15 is a view that illustrates a second embodiment of the present invention, and illustrates an example of a distributed token ledger.

FIG. 16 is a view that illustrates a third embodiment of the present invention, and illustrates an example of a distributed token ledger.

FIG. 17 is a view that illustrates a fourth embodiment of the present invention, and illustrates an example of a company node.

### MODES FOR CARRYING OUT THE INVENTION

Embodiments of the present invention are described below on the basis of the attached drawings.

### First Embodiment

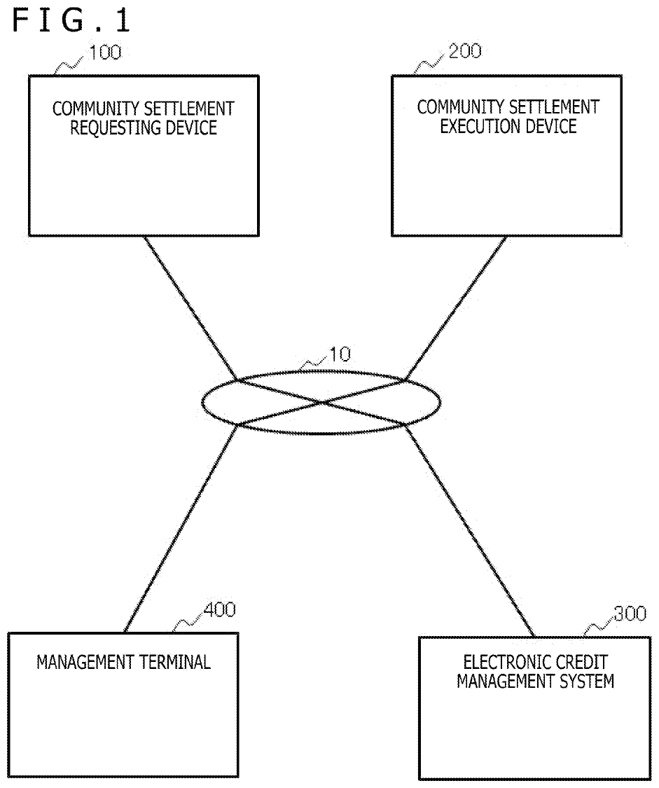

FIG. 1 is a block view that illustrates a first embodiment of the present invention and illustrates an example of a device configuration for a settlement system. The settlement system of the present first embodiment settles commercial transactions by electronic currency (tokens) in a supply chain community made up of manufacturers, suppliers, and so on.

The settlement system includes a community settlement requesting device 100 that executes a request to issue a token which is an electronic settlement medium, executes payment of a token, or executes a request to liquidate a token; a community settlement execution device 200 that executes work such as issuing, discounting or liquidating a token; an electronic credit management system 300 that manages electronic credit (monetary credit) similarly to a conventional example; a management terminal 400 that manages the community settlement requesting device 100 and the community settlement execution device 200; and a network 10 that mutually connects the community settlement requesting device 100, the community settlement execution device 200, the electronic credit management system 300, and the management terminal 400.

One community is formed by companies such as suppliers or manufacturers that make up a supply chain. The community settlement requesting device 100 is disposed at the companies included in this community, and settlement of commercial transactions is performed in accordance with tokens. A community that performs settlement by tokens is referred to below as a token community. In addition, some companies included in the token community are registered as users of the electronic credit management system 300. Note that a financial institution that performs transactions with a company in the token community can also be included in the token community.

The community settlement execution device 200, which performs processing such as issuing, discounting, or liquidating tokens, is disposed at financial institutions that perform transactions with the companies of the community. Each financial institution participates in the electronic credit management system 300.

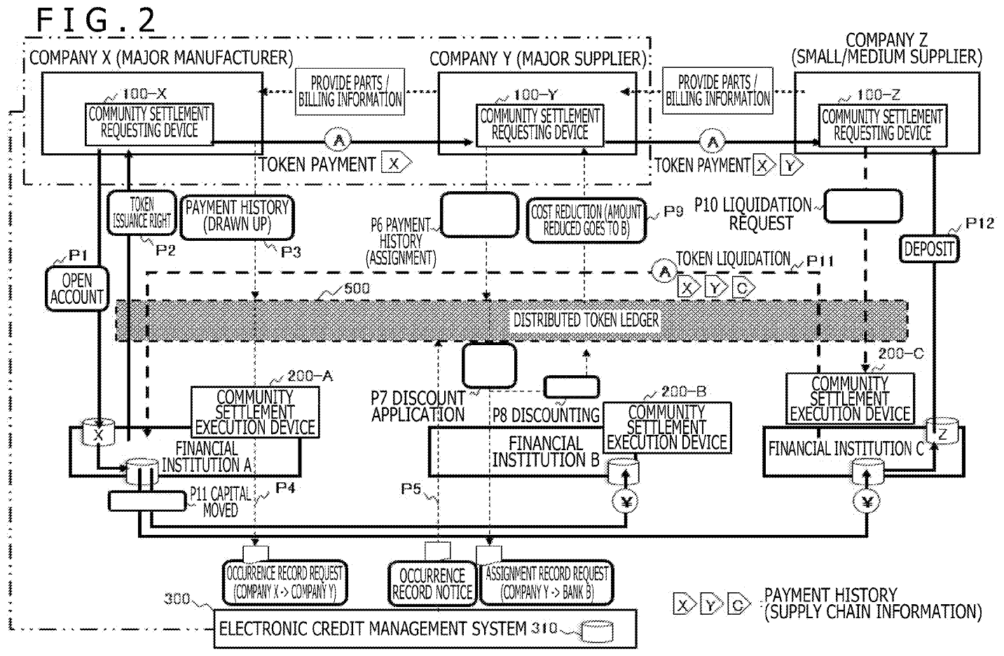

FIG. 2 is a view that illustrates the first embodiment of the present invention, and illustrates an example of a token community that uses the settlement system, and relation between companies and financial institutions. The supply chain is made up by company X that is a paying company (a manufacturer), company Y that is a delivering company (a supplier) that delivers components to company X, and company Z that is a delivering company (a supplier) that delivers components to company Y.

Company X performs transactions with financial institution A, company Y performs transactions with financial institution B, and company Z performs transactions with financial institution C. The financial institutions A through C and the companies X through Z in the supply chain make up a token community that uses tokens.

In the token community, management of tokens is performed by each company and financial institution sharing a distributed token ledger 500. The companies X through Z have community settlement requesting devices 100-X through 100-Z in order to use tokens. Note that, in the following description, when not specifying individual community settlement requesting devices, the reference symbol 100 is used, omitting “-” and thereafter. The same applies to the reference symbols for other components.

The financial institutions A through C have community settlement execution devices 200-A through 200-C in order to manage accounts and token usage. A community settlement execution device 200 manages the distributed token ledger 500, manages accounts, and makes a recording request (proxy request) to the electronic credit management system 300. In addition, a request to the electronic credit management system 300 which is made by the community settlement execution device 200 is a record for, for example, the occurrence of a credit in the token community.

In the token community, the community settlement requesting device 100 and the community settlement execution device 200 share management of the distributed token ledger 500. The community settlement execution devices 200 of the financial institutions A through C link the distributed token ledger 500 with debts (or credits) in the electronic credit management system 300.

Note that the financial institutions A through C participate in the electronic credit management system 300, and company X and company Y are users of the electronic credit management system 300. Company Z does not use the electronic credit management system 300 and therefore cannot use electronic credit.

<Outline>

Description is given below regarding an outline of settlement performed in the token community.

Firstly, the supply chain company X opens a token community account as a representative of the supply chain. The community settlement requesting device 100-X of company X makes a request to the community settlement execution device 200-A of the financial institution A to open an account (issue a token) (P1). The community settlement execution device 200 opens a token community account, and assigns a token issuance right to the community settlement requesting device 100-X of company X (P2).

Next, company X performs payment by token to company Y as consideration for delivery. The community settlement requesting device 100-X of company X notifies the community settlement execution device 200 of financial institution A of a request for payment by token. The community settlement execution device 200-A of the financial institution A records the issuance of a token in the distributed token ledger 500, and issues the token. The community settlement execution device 200-A transmits the issued token to the community settlement requesting device 100-Y of company Y (P3).

Note that the token includes a history of payment from company X, the monetary amount, a payment due date, and a receiver. In addition, regarding content that the community settlement requesting device 100-X writes into the distributed token ledger 500, content of the transaction for which the token has been issued are recorded. Note that the token issued by financial institution A may be transmitted from the community settlement requesting device 100-X of company X to company Y.

At financial institution A that manages the account for company X, the community settlement execution device 200-A obtains from the distributed token ledger 500 the request for payment by token from company X, and causes the occurrence of a debt (monetary debt) from company X to company Y to be recorded in the electronic credit management system 300 (P4). The electronic credit management system 300 accepts the request from the community settlement execution device 200-A, and records the content of the token in an electronic credit management table 310.

By the community settlement execution device 200-A causing content of the token issued in accordance with the payment request from company X to be recorded to the electronic credit management table 310 of the electronic credit management system 300, the value of the token is ensured at the value of the legal tender registered in the electronic credit management system 300. By this, in the settlement system of the present invention, by linking the token community with a settlement system in the real world, it is possible to realize settlement between companies by linking a token, which is an electronic settlement medium in the token community, to legal tender in the real world.

The electronic credit management system 300 notifies a community settlement execution device 200-B of financial institution B of the occurrence of a credit for company Y. The community settlement execution device 200-B of financial institution B, which manages an account for company Y, records the notification of a remittance in the distributed token ledger 500.

Next, company Y requests financial institution B for assignment (discount) of the token before the payment due date for the token. Here, company Y desires for settlement (assignment) by token with respect to a transaction with company Z which does not use the electronic credit management system 300, and applies to financial institution B for assignment to company Z and a discount (P6).

Financial institution B has a usage contract for the electronic credit management system 300 with company Y, and the community settlement execution device 200-B changes the record for the token which is to be discounted to be assignment from company Y to financial institution B, and requests a write to the electronic credit management system 300 (P7).

Financial institution B calculates a discount rate for the token on the basis of credit for company X, sets a discount portion as the share for financial institution B, and issues the remaining monetary amount (value) after the discount as a token to be paid to company Z. In other words, even if payment from company X to company Y is delayed, financial institution B guarantees payment from company Y to company Z, and implements a discount as consideration for the guarantee (P8).

The community settlement execution device 200-B transmits the token having the discounted value to the community settlement requesting device 100-Y of company Y (P9). The community settlement requesting device 100-Y of company Y executes payment by transmitting the token to the community settlement requesting device 100-Z of company Z. Note that token payment from company Y to company Z may be transmitted from the community settlement execution device 200-B of financial institution B to the community settlement requesting device 100-Z of company Z.

Next, company Z, which has received the token, requests financial institution C to liquidate the token on or after the payment due date (P10). The community settlement execution device 200-C of financial institution C requests the community settlement execution device 200-A of financial institution A, which is the issuer of the token, to liquidate the token (P11). The issuer of the token can be obtained by a community settlement execution device 200 referring to the history of the distributed token ledger 500.

The community settlement execution device 200-A accepts the request to liquidate the token, remits the discounted monetary amount of the token from the account for company X to an account for company Z at financial institution C, and remits the discount amount to financial institution C (P11). The community settlement execution device 200-A then requests the electronic credit management system 300 to erase the debt for company X (financial institution A) because payment for the token is complete.

Note that settlement between the financial institutions A through C does not need to be in units of accounts, and can use netting which is for settling differences in a consolidated fashion every certain due date.

In the settlement system of the present invention as above, by linking a token community with an existing settlement system (the electronic credit management system 300) by the distributed token ledger 500, it is possible to perform settlement in the token community while ensuring the value of an electronic settlement medium. Even if some companies in the token community have not joined the existing settlement system, it is possible to perform settlement safety.

<Community Settlement Requesting Device>

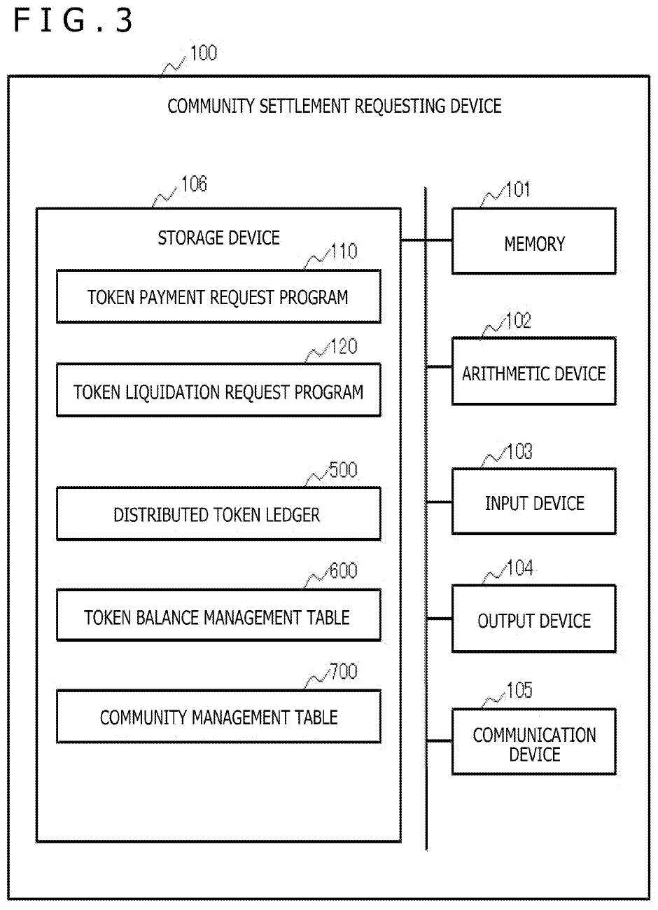

FIG. 3 is a block view that illustrates an example of the community settlement requesting device 100. The community settlement requesting device 100 is a computer that includes a memory 101, an arithmetic device 102, an input device 103, an output device 104, a communication device 105, and a storage device 106.

The storage device 106 stores a token payment request program 110 for requesting a financial institution for payment by token, a token liquidation request program 120 for requesting a financial institution to liquidate an accepted token, a distributed token ledger 500 for sharing tokens within the token community, a token balance management table 600, and a community management table 700.

The input device 103 is configured by a keyboard, mouse, or a touch panel, for example. The output device 104 is configured by a display or the like, for example. The communication device 105 is connected to the network 10, and communicates with other computers.

The token payment request program 110 and the token liquidation request program 120 are executed by the arithmetic device 102 after being loaded into the memory 101.

The arithmetic device 102 executes processing in accordance with a program for each functional unit to thereby operate as a functional unit that provides a predetermined function. For example, the arithmetic device 102 functions as a token payment request unit by executing processing in accordance with the token payment request program 110. It is similar in regard to other programs. Furthermore, the arithmetic device 102 operates as a functional unit that provides each function of a plurality of processes that respective programs perform. A computer and a computer system are a device and a system that includes these functional units.

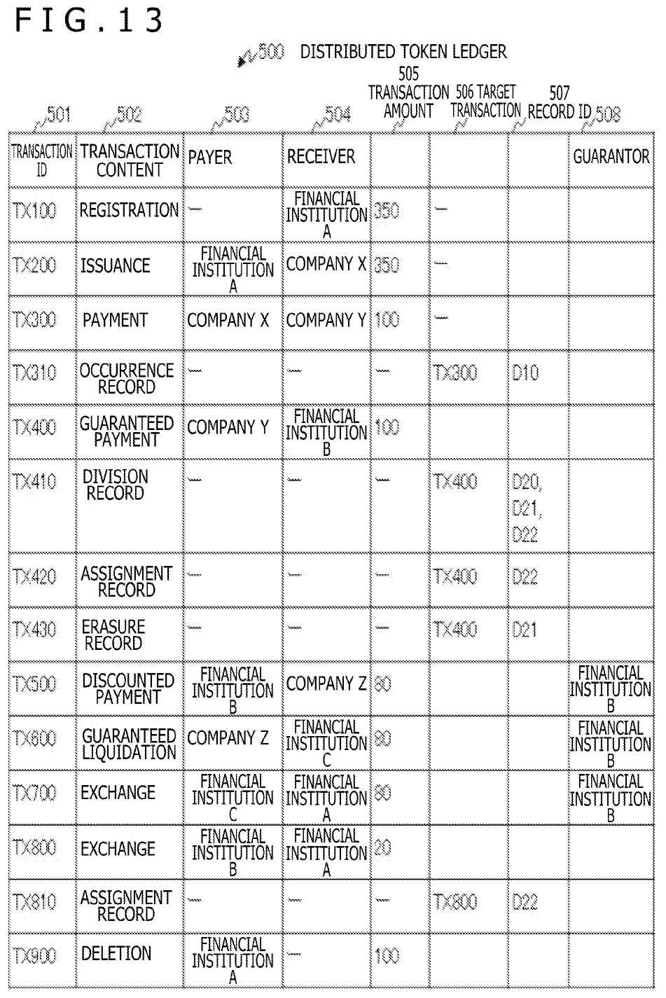

The distributed token ledger 500 is a management ledger that is distributed among and shared by participants in the token community. In the present first embodiment, token information is shared by storing the distributed token ledger 500 in each community settlement requesting device 100 of the companies X through Z and each community settlement execution device 200 of the financial institutions A through C. FIG. 13 is a view that illustrates an example of the distributed token ledger 500.

The distributed token ledger 500 is updated by a community settlement execution device 200 of the financial institutions A through C or a community settlement requesting device 100 of the companies X and Z. The distributed token ledger 500 includes a transaction ID 501, transaction content 502, a payer 503, a receiver 504, a transaction amount 505, a target transaction 506, a record ID 507, and a guarantor 508 in one entry.

The transaction ID 501 stores an identifier (ID) of a transaction that is generated in token processing. The transaction identifier is assigned by a community settlement execution device 200 or a community settlement requesting device 100 and is a unique value in the token community.

The transaction content 502 stores processing content for the token, or content of processing at a company or a financial institution. The payer 503 stores the name of the remitter of the token. The receiver 504 stores the receiver of the token. The transaction amount 505 stores the monetary amount (or value) of the token.

The target transaction 506 stores a transaction ID related to a corresponding transaction. An identifier for the electronic credit management system 300, which stores information relating to the corresponding transaction, is set to the record ID 507. The record ID 507 can store one or more identifiers, using values set by the electronic credit management system 300. The guarantor 508 stores the name of a person or institution that ensures the transaction amount of the corresponding transaction.

FIG. 12 is a view that illustrates an example of the token balance management table 600. The token balance management table 600 is distributed among and shared by the participants in the token community, and is updated by the community settlement execution devices 200 of the financial institutions A through C.

The token balance management table 600 includes a token name 601, a token balance 602, an expiration date 603, and an exchange start date 604 in one entry. The token name 601 stores a name or an identifier decided by a community settlement execution device 200 of the financial institutions A through C. Note that the token name 601 has a unique value in the token community.

The token balance 602 stores the value (monetary amount) of the token. The expiration date 603 stores the last day of a period of time during which the token can be used. The exchange start date 604 stores the date from which the token can be exchanged into currency. Note that the token balance 602 stores the latest balance of the token.

FIG. 11 is a view that illustrates an example of the community management table 700. The community management table 700 is distributed among and shared by the participants in the token community, and is set by the community settlement execution devices 200 of the financial institutions A through C.

The community management table 700 includes a token name 701, an issue amount 702, a participant name 703, a representative flag 704, and a Densai (electronic record credit service in Patent Document 1 described above) contract presence/absence 705 in one entry.

The token name 701 stores an identifier or a name for the token. The issue amount 702 stores the value (monetary amount) of the token that can be issued. The participant name 703 stores the name of participants in the token community that can use the token.

The representative flag 704 is set to “Y” for the representative of the token community. Note that, in the present first embodiment, description is given for an example in which the payer of the token (company X) is the representative and the representative decides the participant names 703, but there is no limitation to this.

The Densai contract presence/absence 705 is set to “Y” for participants who have entered into a usage contract for the electronic credit management system 300, from among participants in the token community. Note that, in the present first embodiment, description is given for an example in which the electronic credit management system 300 is used as a settlement system in the real world, but there is no limitation to this. For example, usage is possible in the case of a settlement system in which debts or credits can be registered.

In addition, in the present first embodiment, it is assumed that the representative of the token community has a usage contract with the electronic credit management system 300.

Information such as additions or changes by participants in the token community are recorded in the distributed token ledger 500 as needed, and the latest state is reflected to the community management table 700.

<Community Settlement Execution Device>

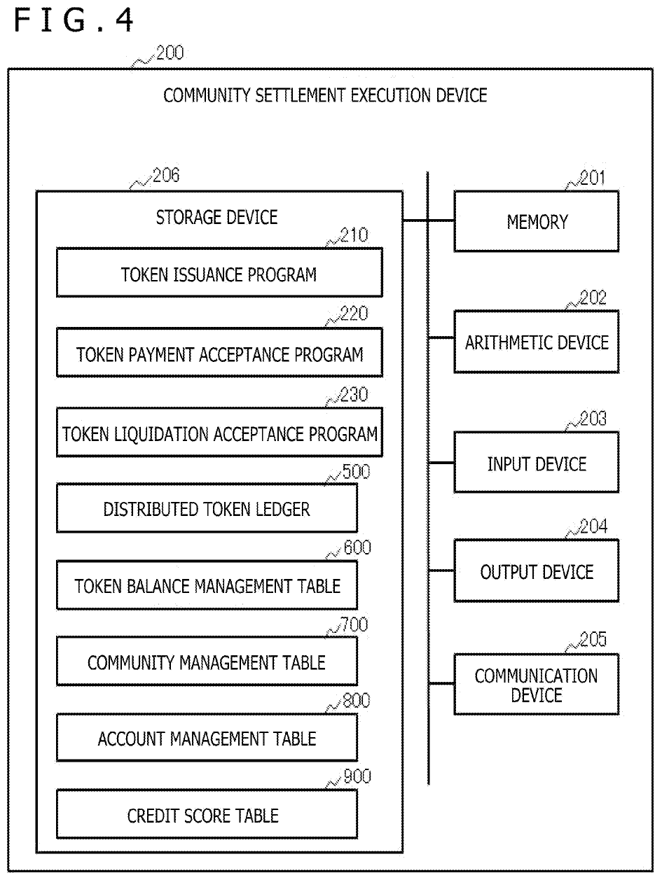

FIG. 4 is a block view that illustrates an example of the community settlement execution device 200. The community settlement execution device 200 is a computer that includes a memory 201, an arithmetic device 202, an input device 203, an output device 204, a communication device 205, and a storage device 206.

The storage device 206 stores a token issuance program 210 for issuing a token, a token payment acceptance program 220 for processing a token payment request, a token liquidation acceptance program 230 for processing the liquidation of a token, the distributed token ledger 500, the token balance management table 600, the community management table 700, an account management table 800, and a credit score table 900.

Note that, the distributed token ledger 500, the token balance management table 600, and the community management table 700 are similar to those in the community settlement requesting device 100, and thus description thereof is omitted.

The input device 203 is configured by a keyboard, mouse, or a touch panel, for example. The output device 204 is configured by a display or the like. The communication device 205 is connected to the network 10, and communicates with other computers.

The arithmetic device 202 executes processing in accordance with a program for each functional unit, to thereby operate as a functional unit that provides a predetermined function. For example, the arithmetic device 202 functions as a token issuing unit by executing processing in accordance with the token issuance program 210. It is similar in regard to other programs.

Furthermore, the arithmetic device 202 operates as a functional unit that provides each function of a plurality of processes that respective programs perform. A computer and a computer system are a device and a system that includes these functional units.

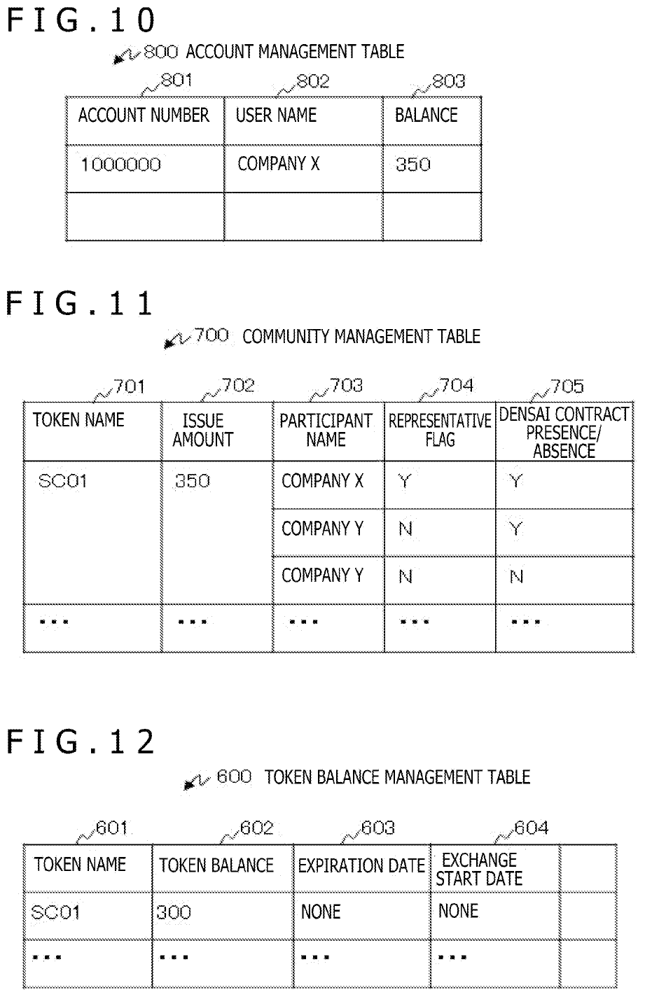

FIG. 10 is a view that illustrates an example of the account management table 800. The account management table 800 is managed by the community settlement execution devices 200 of the financial institutions A through C. The account management table 800 includes an account number 801, a user name 802, and a balance 803 in one entry.

The credit score table 900 is not illustrated, but a score indicating a degree of credit is set therein for each participant in the token community. A community settlement execution device 200 of the financial institutions A through C can refer to a score in the credit score table 900 to decide, for example, a discount rate for a token.

<Electronic Credit Management System>

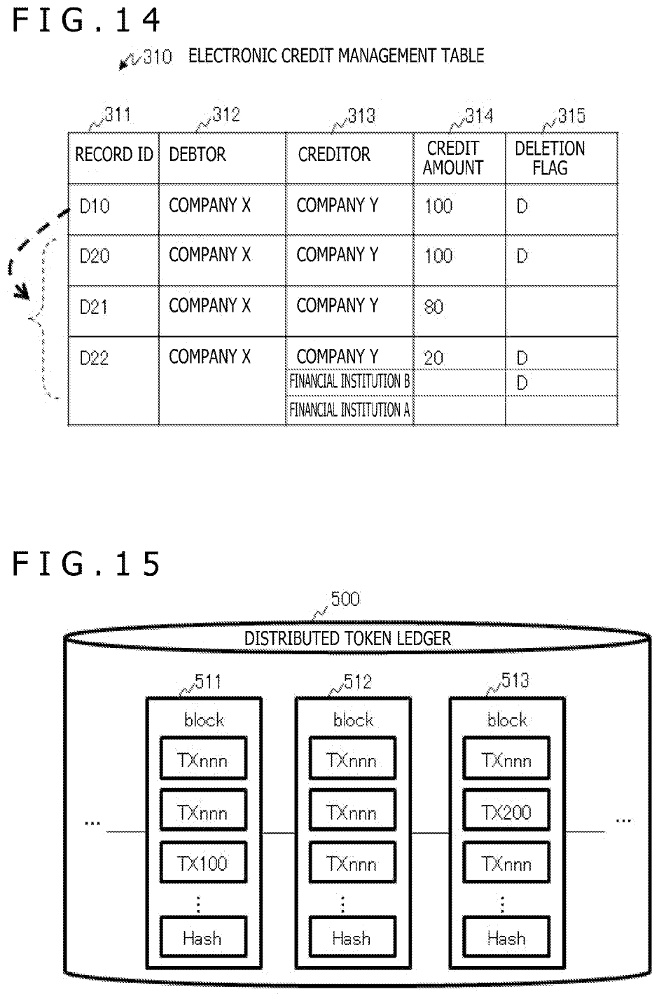

The electronic credit management system 300 is a computer system or a computer that provides a well-known electronic record credit service or the electronic record credit service called Densai in Patent Document 1 described above. FIG. 14 is a view that illustrates an example of the electronic credit management table 310 managed by the electronic credit management system 300.

The electronic credit management table 310 includes a record ID 311, a debtor 312, a creditor 313, a credit amount 314, and a deletion flag 315 in one entry. The record ID 311 is a unique value that is an identifier assigned by the electronic credit management system 300, and corresponds to the record ID 507 in the distributed token ledger 500.

The debtor 312 and the creditor 313 store a full name or a corporate name. The credit amount 314 stores a monetary amount. The deletion flag 315 stores “D” for an entry that has been deleted.

In the illustrated example, credit for company Y for which the credit amount 314 is “100” is divided after being discounted by the financial institution B into credit for company Y for which the credit amount 314 is “80,” and credit for financial institution A for which the credit amount 314 is “20.”

Note that, in the first embodiment described above, description is given for an example in which the electronic credit management system 300 is used as an existing settlement system that manages credits, but the electronic credit management system 300 may be a single computer such as an electronic credit management device.

<Processing>

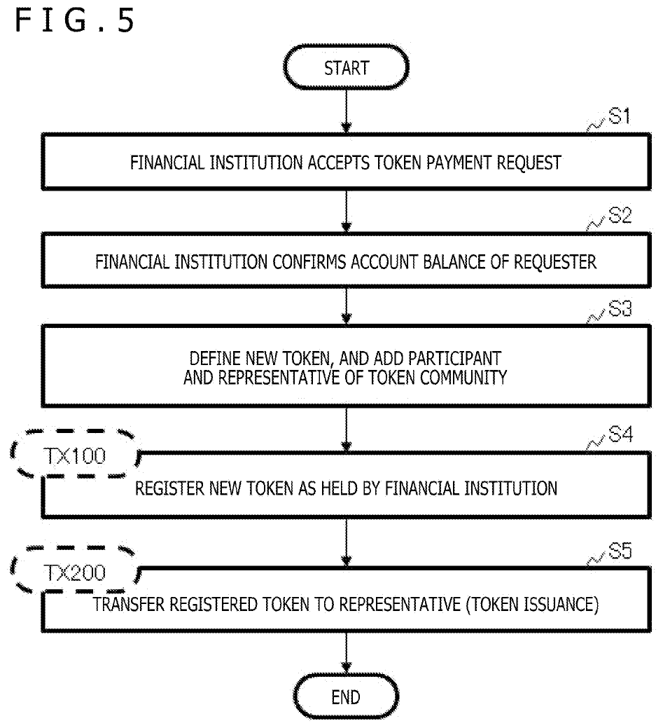

FIG. 5 is a flow chart that illustrates an example of a token issuance process. This process is started when the token issuance program 210 of the community settlement execution device 200 of a financial institution accepts a token issuance request from the community settlement requesting device 100 of a company.

The following description describes a community settlement execution device 200 as the agent of processing, but the token issuance program 210 or the arithmetic device 202 may be the agent of processing.

The community settlement execution device 200 accepts a token payment request from the community settlement requesting device 100 of a company (S1). The community settlement execution device 200 refers to the account management table 800 to obtain the account balance of the user that has requested token payment, and determines whether there is not insufficient balance with respect to the payment amount (S2).

Next, the community settlement execution device 200 decides the name of the token, and registers information such as the participant and the payment amount included in the token payment request in the community management table 700 (S3).

The community settlement execution device 200 sets the decided name of the token to the token name 701 of the community management table 700, sets the issue amount 702, registers the transmission source of the payment request as the representative in the participant name 703, sets the representative flag 704 to “Y,” and sets the Densai contract presence/absence 705 in accordance with whether or not there is a usage contract for the electronic credit management system 300.

In addition, the community settlement execution device 200 sets the participant name 703, the representative flag 704=“N,” and the Densai contract presence/absence 705 for the participants of the token community that are set in the payment request.

The community settlement execution device 200 registers, in the distributed token ledger 500, a new token decided as described above, as a token that the financial institution holds (S4). In the present first embodiment, description is given for an example in which the community settlement execution device 200 adds an entry, for which the transaction ID 501 is “TX100,” as a new token, and registers the entry in the distributed token ledger 500 of FIG. 13.

The community settlement execution device 200 transfers the new token issued by the financial institution to the ownership of the representative who has requested payment, and completes issuance of the token (S5). In the present first embodiment, the community settlement execution device 200 adds an entry for which the transaction content 502 is “issuance” with the transaction ID 501=“TX200.” In the example of FIG. 13, a transfer from financial institution A to company X is registered in the distributed token ledger 500 with content in which the payer 503 is “financial institution A” and the receiver 504 is “company X.”

According to the process described above, a new token registered by the financial institution in the distributed token ledger 500 is issued as a token for payment by company X with the transaction ID 501 of “TX200.” The participants in the token community are notified of issuance of the new token according to the distributed token ledger 500.

Note that it is possible to use an existing account that is for settlement, such as a checking account for the account at the financial institution that is for issuing the token, or a special account that is for token settlement may be used. In addition, the issue amount of the token may be designated in the request for issuance, or the entire balance may be set as the issue amount without designation being performed.

In addition, description is given above for an example in which participants in the community are designated at the time of a token payment request, but there is no limitation to this. For example, the representative of the community may register participants separately. Alternatively, it may be that a participant that is not the representative applies to participate, and the representative approves this and registers them in the community management table 700.

It may be that a financial institution or another organization determines that company X, company Y, and company Z make up a supply chain on the basis of transaction history or the like that is not illustrated, and registers company X through company Z in the participant name 703.

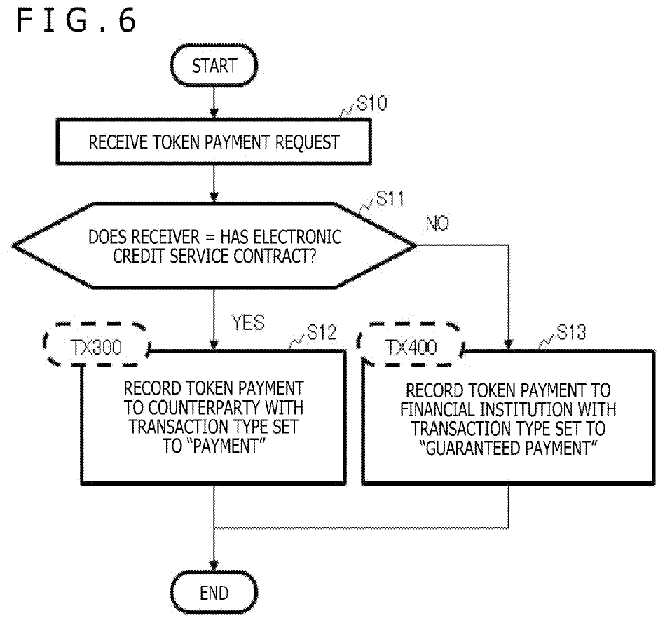

FIG. 6 is a flow chart that illustrates an example of a token payment request process. This process is started when the token payment request program 110 of the community settlement requesting device 100 of a company accepts a token payment request from a user.

The community settlement requesting device 100 accepts the token payment request from the input device 103 or the like (S10). The token payment request includes a payment amount, a receiver, a payment due date, and the like.

The community settlement requesting device 100 refers to the community management table 700 to determine whether the receiver has a usage contract for the electronic credit management system 300. If the receiver is a user of the electronic credit management system 300, the process proceeds to step S12, and otherwise the process proceeds to step S13.

In step S12, the community settlement requesting device 100 registers, in the distributed token ledger 500, payment of the token to the receiver with the transaction content 502 set to “payment.” In the present first embodiment, description is given for an example in which an entry of the transaction ID 501=“TX300” with payment from company X to company Y is registered by the community settlement requesting device 100 in the distributed token ledger 500.

Meanwhile, in step S13, because the receiver cannot use the electronic credit management system 300, the community settlement requesting device 100 registers payment to the financial institution B that is the receiver in the distributed token ledger 500, with the transaction content 502 set to “guaranteed payment.” In the present first embodiment, description is given for an example in which registration to the distributed token ledger 500 is performed with the financial institution B set to the receiver and with the transaction ID 501=“TX400” when company Y pays company Z, which has not joined the electronic credit management system 300, by token, as illustrated in FIG. 2.

The “guaranteed payment” token with the transaction ID 501=“TX400” has the payer 503 as “company Y” and the receiver 504 as “financial institution B” indicates an example in which the financial institution B ensures payment to company Z.

According to the process described above, a payment transaction (TX300 or TX400) is registered in the distributed token ledger 500. The community settlement execution device 200 of a financial institution can refer to the distributed token ledger 500 to detect that a request for payment from company X to company Y (company Z) has newly occurred.

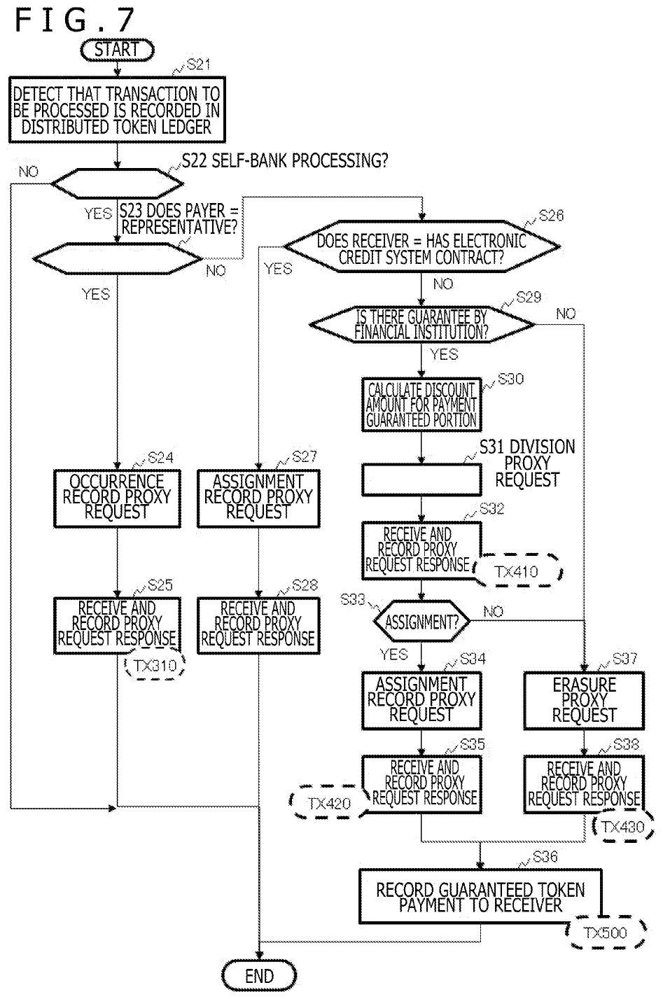

FIG. 7 is a flow chart that illustrates an example of a token payment acceptance process. This process is started when the token payment acceptance program 220 of the community settlement execution device 200 of a financial institution detects a new payment request in the distributed token ledger 500.

The community settlement execution device 200 detects an entry for a new payment request from the distributed token ledger 500, and reads out the payer 503, the receiver 504, and the transaction ID 501 (S21).

In step S22, the community settlement execution device 200 refers to the account management table 800 and determines, on the basis of whether there is an account for the payer, whether the payment is processing to be performed by the financial institution itself (hereinafter referred to as self-bank). In the case where the payment is performed by the self-bank, the process proceeds to step S23, and otherwise the process ends.

Next, in step S23, the community settlement execution device 200 refers to the community management table 700 to determine whether or not the payer is the representative. In the case where the payer is the representative, the process proceeds to step S24, and otherwise the process proceeds to step S26.

In step S24, the community settlement execution device 200 requests (proxy request) the electronic credit management system 300 to record (occurrence record) that a debt has occurred for the payer.

In step S25, the community settlement execution device 200 receives a response from the electronic credit management system 300 with respect to proxy request, and records the received content in the distributed token ledger 500. The community settlement execution device 200 accepts an identifier of the occurrence record as the response to the proxy request, generates “TX310” as the transaction ID 501 related to the transaction ID 501=“TX300” for the payment, and adds an entry to the distributed token ledger 500.

The community settlement execution device 200 stores an identifier “D10” assigned by the electronic credit management system 300 to the record ID 507 of the entry, stores the transaction ID 501=“TX300” of the payment entry in the target transaction 506, and then ends the process.

Meanwhile, in the case where the payer is not the representative in step S22, the community settlement execution device 200, in step S26, refers to the community management table 700 to determine whether the receiver 504 (operator of the community settlement requesting device 100 that has issued the payment request) has a usage contract for the electronic credit management system 300. In a case where there is a usage contract, the process proceeds to step S27, and otherwise the process proceeds to step S29.

In step S27, the community settlement execution device 200 requests (proxy request) the electronic credit management system 300 to record (assignment record) that a debt has occurred for the payer, who is not the representative. The process in this case is that the credit is assigned from the representative (or another participant) to the corresponding receiver.

In step S28, the community settlement execution device 200 receives a response from the electronic credit management system 300 with respect to the proxy request, and records the received content in the distributed token ledger 500. The community settlement execution device 200 accepts an identifier for the assignment record as the response to the proxy request, generates a new transaction ID 501 related to the transaction ID 501 of the payment, and adds a new entry to the distributed token ledger 500.

The community settlement execution device 200 stores an identifier assigned by the electronic credit management system 300 in the record ID 507 of the entry, stores the transaction ID 501 of the payment transaction in the target transaction 506, and then ends the process.

In step S29 which is for the case where the receiver has no usage contract for the electronic credit management system 300 by the determination in step S26 described above, the community settlement execution device 200 determines whether it is possible to apply a guarantee to the payer. This process determines whether the community settlement execution device 200 will apply a guarantee on the basis of predetermined criteria for credit history, transaction history with the financial institution, or payment due date. In a case of applying a guarantee, the process proceeds to step S30, and in a case of not applying a guarantee, the process proceeds to step S37.

In step S30, in order to discount the token, the community settlement execution device 200 refers to the credit score table 900 to calculate the discount amount with respect to the payment amount from the credit score of the payer. Next, in step S31, the community settlement execution device 200 divides the token into a share for the financial institution and a share for the receiver, and requests (proxy request) the electronic credit management system 300 to register the content of the division.

Note that, as for the value of the token, the discount amount is set as the share for the financial institution, and the remainder after subtracting the discount amount from the payment amount is set as the share for the receiver.

Note that token division is performed between two parties, which include the financial institution and the receiver, in the case where the receiver liquidates the token before the payment due date, but in the case where the receiver remits to another receiver before the payment due date for the token, assignment from the receiver to the other receiver is performed after division between the financial institution and the receiver.

In step S32, the community settlement execution device 200 receives a response from the electronic credit management system 300 with respect to proxy request, and records the received content in the distributed token ledger 500. The community settlement execution device 200 accepts the identifiers “D20, D21, and D22” of the division record as the response to the proxy request, generates “TX410” as the transaction ID 501 relating to the transaction ID 501=“TX400” of the guaranteed payment, and adds an entry to the distributed token ledger 500.

The community settlement execution device 200 stores the identifiers “D20, D21, and D22” assigned by the electronic credit management system 300 in the record ID 507 of the entry, and stores the transaction (transaction ID 501) “TX400” of the guaranteed payment in the target transaction 506.

In step S33, it is determined whether the divided token described above includes assignment to the receiver. In the case where there is a receiver the process proceeds to step S34 because there is assignment, and otherwise the process proceeds to step S37.

In step S34, in order to assign the token, the community settlement execution device 200 requests (proxy request) the electronic credit management system 300 to register (assignment record) content of the assignment to the receiver.

In step S35, the community settlement execution device 200 receives a response from the electronic credit management system 300 with respect to proxy request, and records the content received in the distributed token ledger 500. The community settlement execution device 200 accepts an identifier “D22” of the assignment record as the response to the proxy request, generates “TX420” as the transaction ID 501 related to the transaction ID 501=“TX400” of the payment, and adds an entry to the distributed token ledger 500.

The community settlement execution device 200 stores the identifier “D22” assigned by the electronic credit management system 300 in the record ID 507 of the entry, and stores the transaction (transaction ID 501) “TX400” of the guaranteed payment in the target transaction 506.

Next, in step S36, the community settlement execution device 200 records guaranteed payment from the payer (financial institution B) to the receiver (company Z) in the distributed token ledger 500. The community settlement execution device 200 generates “TX500” as the transaction ID 501 of the guaranteed payment, and adds an entry to the distributed token ledger 500. The community settlement execution device 200 stores “financial institution B” in the guarantor 508 of the entry, stores “financial institution B” in the payer 503, and stores “company Z” in the receiver 504.

Meanwhile, in step S37 which is for the case where there is no assignment by the determination in step S33, because the payer's debt has been erased, in order to erase the token, the community settlement execution device 200 requests (proxy request) the electronic credit management system 300 to erase the guaranteed payment for which the transaction ID 501 is “TX 400.”

In step S38, the community settlement execution device 200 receives a response from the electronic credit management system 300 with respect to proxy request, and records the content received in the distributed token ledger 500. The community settlement execution device 200 accepts an identifier “D21” of the erasure record as the response for the proxy request, generates “TX430” as the transaction ID 501 relating to the transaction ID 501=“TX400” for the payment, and adds an entry to the distributed token ledger 500.

The community settlement execution device 200 stores the identifier “D21” assigned by the electronic credit management system 300 in the record ID 507 of the entry, and stores the transaction (transaction ID 501) “TX400” for the guaranteed payment in the target transaction 506.

According to the process described above, token payment, assignment, division, and erasure are recorded in the distributed token ledger 500, content of changes are registered in the electronic credit management system 300 each time movement or change of the debt (credit) occurs, and the settlement system can guarantee the value of the token for the debtor and the creditor.

In addition, by the process described above, in the case where the payer is not the representative of the token community and the receiver 504 does not have a usage contract for the electronic credit management system 300, it is possible to perform a discount by the financial institution that performs payment, and the financial institution ensures the debt in place of the payer. By this, it becomes possible to guarantee the value of a token, similarly to with legal tender, even with respect to a receiver that does not have a usage contract for the electronic credit management system 300.

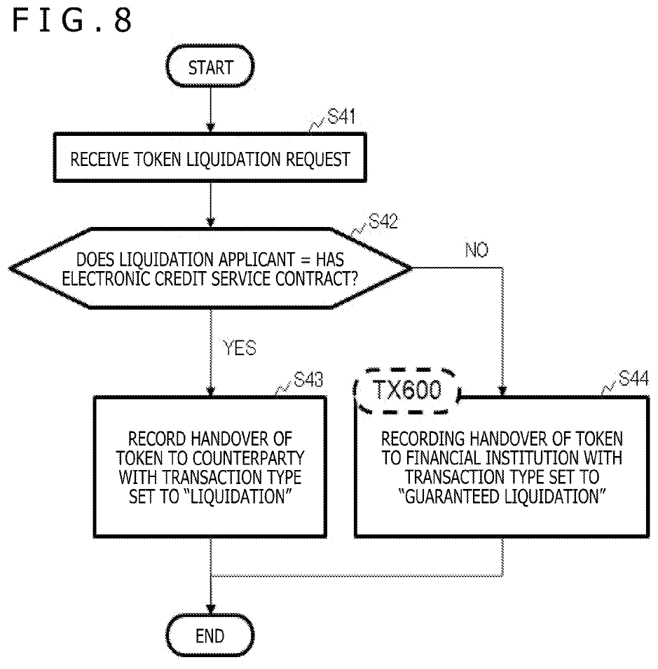

FIG. 8 is a flow chart that illustrates an example of a token liquidation request process. This process is started when the token liquidation request program 120 of the community settlement requesting device 100 of a company accepts a token liquidation request from a user.

The community settlement requesting device 100 accepts a token liquidation request from the input device 103 or the like (S41). The community settlement requesting device 100 obtains the transaction ID 501 (or token name), the monetary amount and the user name (participant name 703) from the liquidation request.

The community settlement requesting device 100 refers to the community management table 700 to determine whether the user of the liquidation request has a usage contract for the electronic credit management system 300 (S42). In a case where the user has a usage contract, the community settlement requesting device 100 advances the process to step S43, and advances the process to step S44 in a case where the user has no usage contract.

In step S43, the community settlement requesting device 100 adds, to the distributed token ledger 500, handover of the token with the transaction content 502 set to “liquidation.” Meanwhile, in step S44, the community settlement requesting device 100 adds, to the distributed token ledger 500, handover of the token with the transaction content 502 set to “guaranteed liquidation.” In the case of “guaranteed liquidation,” the community settlement requesting device 100 stores the name (or identifier) of a financial institution as the guarantor 508 in the distributed token ledger 500.

FIG. 13 indicates that, for the transaction ID 501=“TX600,” guaranteed liquidation is registered in which the receiver 504 is “financial institution C” with the guarantor 508 as “financial institution B.”

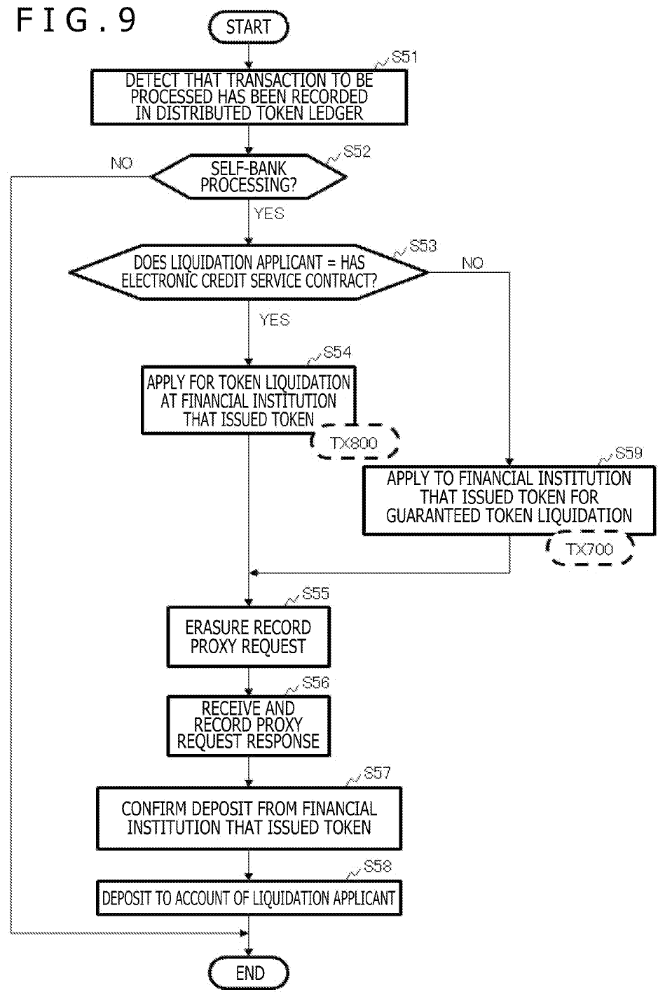

FIG. 9 is a flow chart that illustrates an example of a token liquidation acceptance process.

This process is started when the token liquidation acceptance program 230 of the community settlement execution device 200 of a financial institution detects a new liquidation request in the distributed token ledger 500.

The community settlement execution device 200 detects a new liquidation entry from the distributed token ledger 500, and reads the payer 503, the receiver 504, and the transaction ID 501 (or token name) from the token to be liquidated (S51).

The community settlement execution device 200 then refers to the account management table 800 to determine whether the receiver 504 holds an account at the self-bank (S52). In a case where the receiver 504 holds an account at the self-bank, the process advances to step S53, and otherwise the process ends.

In step S53, the community settlement execution device 200 refers to the community management table 700 to determine whether the receiver 504 has a usage contract for the electronic credit management system 300. In a case where the receiver 504 has a usage contract for the electronic credit management system 300, the process proceeds to step S54, and otherwise the process proceeds to step S59.

In step S54, the community settlement requesting device 100 refers to the distributed token ledger 500 to specify, on the basis of the record ID 507 for the token to be liquidated, the financial institution that has issued the token, and applies to the financial institution to liquidate the token.

The community settlement execution device 200 notifies the financial institution, which is the issuer, of the application for liquidation by adding a new liquidation (exchange) request to the distributed token ledger 500. For example, with the transaction ID 501 of “TX800” in FIG. 13, a new transaction with the transaction content 502 of “exchange,” the payer 503 of “financial institution B,” and the receiver 504 of “financial institution A” is added.

In step S55, the community settlement execution device 200 requests (proxy request) the electronic credit management system 300 for addition of a record (erasure record) that erases the debt at the financial institution that has accepted the liquidation request.

In step S56, the community settlement execution device 200 receives a response from the electronic credit management system 300 with respect to proxy request, and records the received content in the distributed token ledger 500.

The community settlement execution device 200 accepts an identifier “D22” for the erasure record as the response to the proxy request, generates “TX810” as the transaction ID 501 related to the transaction ID 501=“TX800” for the payment, and adds an entry to the distributed token ledger 500.

The community settlement execution device 200 stores the identifier “D22” assigned by the electronic credit management system 300 in the record ID 507 for the entry, and stores the transaction (transaction ID 501) “TX800” for the payment in the target transaction 506.

Next, when the community settlement execution device 200 detects a deposit from the financial institution that has issued the token (S57), the community settlement execution device 200 makes a deposit to the account of the user who has applied for the liquidation request, and ends the process (S58).

In the case where the applicant for the liquidation request does not have a usage contract for the electronic credit management system 300 in the determination of step S53 described above, the process proceeds to step S59, and the community settlement execution device 200 applies to the financial institution that is the issuer of the token for guaranteed liquidation. The guarantee of the debt with respect to the token is that the financial institution, which operates the community settlement execution device 200 that has accepted the liquidation request, becomes the guarantor. Note that, as described above, the community settlement execution device 200 notifies the financial institution, which is the issuer, of the application for liquidation by adding a new liquidation request to the distributed token ledger 500.

For example, with the transaction ID 501 of “TX700” in FIG. 13, an entry with the transaction content 502 of “exchange,” the payer 503 of “financial institution C,” and the receiver 504 of “financial institution A” is added. In this entry, “financial institution B” is registered to the guarantor 508 because the financial institution B that has accepted the liquidation request guarantees the debt. Subsequently, a request for erasure registration is made to the electronic credit management system 300 similarly to as described above, and a deposit from the financial institution A is made to the account of the applicant.

According to the process described above, it is possible to liquidate a token and make a deposit to an account of an applicant, irrespective of the presence or absence of a usage contract for the electronic credit management system 300.

In the settlement system of the present first embodiment as above, it is possible to realize settlement after guaranteeing the value of an electronic settlement medium (a token), even with a community in which there is a company (operator) that does not participate in the electronic credit management system 300. Note that, in the first embodiment described above, description is given for an example in which a token is used as an electronic settlement medium, but there is no limitation to this, and it is possible to use a virtual currency, points, or the like as an electronic settlement medium.

In addition, in the present first embodiment, description is given for an example in which the value of a token is guaranteed with legal tender, but there is no limitation to this, and, for example, it is possible to guarantee the value of the token by a precious metal such as gold.

In addition, in the present first embodiment, description is given of an example in which the distributed token ledger 500, the token balance management table 600, and the community management table 700 are tables, but these items of information are not limited to tables and may be stored as schemaless data.

In addition, in the present first embodiment, description is given of an example in which the distributed token ledger 500 is shared by participants in the token community, but restrictions may be provided on viewing of information. For example, it is possible to permit financial institutions and parties who are the payer and receiver to view information regarding payment or liquidation, and prohibit viewing by other participants.

Note that, in the present first embodiment, description is given of an example in which the token community is made up by a single community, but there is no limitation to this. For example, it is possible to set a plurality of subcommunities having different scopes for sharing the distributed token ledger 500, and use the subcommunities separately in alignment with the scope of disclosure of transaction content.

In addition, in the first embodiment described above, description is given for an example in which the present invention is applied to a supply chain for between companies, but there is no limitation to this. It is possible to employ the settlement system of the present first embodiment in the case of a community for which the movement of capital is needed.

In addition, in the first embodiment described above, description is given for an example in which the community settlement execution device 200 is disposed at a financial institution, but there is no limitation to this. For example, it is sufficient if the community settlement execution device 200 is at a settlement service company or an organization or group that can pay legal tender to the token community and can make requests to the electronic credit management system 300 for the occurrence to the extinguishment of credit corresponding to a token.

### Second Embodiment

FIG. 15 is a view that illustrates a second embodiment of the present invention, and illustrates an example of the distributed token ledger 500. In the present second embodiment, description is given for an example in which a blockchain is applied to the distributed token ledger 500, one entry illustrated in FIG. 13 is set as one transaction, and blocks 511, 512, and 513 are configured by a plurality of transactions and a hash value. Other configurations are similar to those in the first embodiment described above.

In each of the blocks 511 through 513, the hash value of the block is calculated from the content of the plurality of transactions in the block and the hash value of the immediately prior block, and the content of the transactions and the hash value are held in each of the blocks 511 through 513.

The technique for a blockchain is well-known, and is a distributed ledger management system that combines a P2P network, a consensus algorithm, smart contracts, anti-counterfeiting, and encryption technology.

In the present second embodiment, description is given for an example that uses decentralization, transparency, tamper resistance, fault tolerance, and automatic execution (automatic transactions) from among the characteristics of a blockchain.

Firstly, decentralization indicates that a specific participant is prohibited from monopolizing management of data, and each participant that joins the blockchain can manage data.

Next, transparency indicates that information generated by each participant is published to all participants, and is shared by all participants. A participant that participates in the token community can view all information, and the consistency of recorded information is guaranteed.

Tamper resistance indicates that transactions are generated by participants, and tampering with data is deterred by linking transactions with each other in a chain shape on the basis of electronic signatures and hash values. In addition, by publishing information generated by each participant, it is possible to suppress motivation to tamper with data.

Fault tolerance is preventing data from being damaged or disappearing, even if a failure occurs for some participants, by each participant holding data or a copy of data among the participants in the blockchain.

Automatic execution (automatic transactions) indicates that a transaction or issuance of information is executed after determination results pertaining to a plurality of necessary conditions are aggregated. Alternatively, it indicates that agreement in relation to issued information is efficiently performed.

Note that, in the second embodiment described above, description is given for an example in which the hash value of a block is calculated from the content of transactions and the hash value of the immediately prior block, but there is no limitation to this.

For example, it may be that a hash value of the content of a transaction and the identifier (transaction ID 501) are stored in place of the content of the transaction in each block. In this case, it is sufficient if the hash value of the block is calculated from the hash value of the immediately prior block, the hash value of the content of the transaction, and the identifier of the transaction.

It is sufficient if the content of a transaction is held by each participant. In addition, a device that stores the content of the transactions of each participant may be provided. In this case, it is possible to make the content of each transaction be private, and it is possible to provide the content of the transactions to limited participants from among the participants.

### Third Embodiment

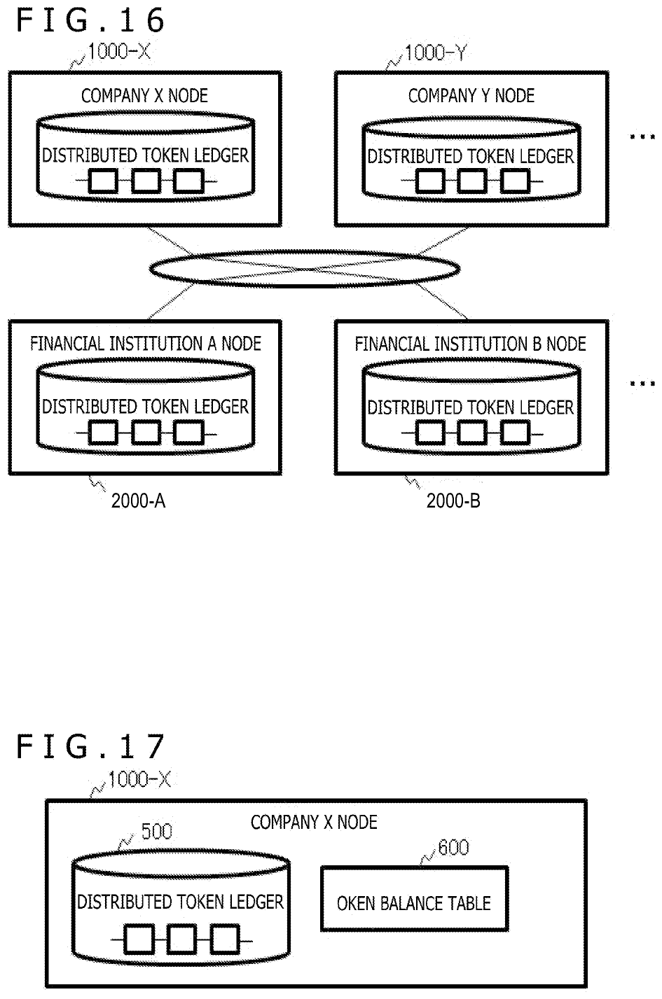

FIG. 16 illustrates a third embodiment, and illustrates an example in which the community settlement requesting device 100 and the community settlement execution device 200 are handled as nodes that manage the distributed token ledger 500.

A company X node 1000-X corresponds to the community settlement requesting device 100-X (refer to FIG. 2) of the first embodiment, and a company Y node 1000-Y corresponds to the community settlement requesting device 100-Y of the first embodiment. A financial institution A node 2000-A corresponds to the community settlement execution device 200-A (refer to FIG. 2) of the first embodiment, and a financial institution B node 2000-B corresponds to the community settlement execution device 200-B (refer to FIG. 2) of the first embodiment.

Since the configuration of each node is the same, description is given below regarding the company X node 1000X, and description for other nodes is omitted. FIG. 17 is a block view that illustrates an example of the company X node 1000X.

The company X node 1000-X holds a copy of the distributed token ledger 500, calculates the latest balance of each token from the distributed token ledger 500, and stores the latest balance of each token in the token balance management table 600. The distributed token ledger 500 is configured by the blockchain illustrated in the second embodiment described above. Note that the master of the distributed token ledger 500 is the distributed token ledger 500 of the financial institution A, and the other nodes hold copies.

According to the configuration described above, it is possible to provide a settlement system provided with fault tolerance and tamper resistance.

### SUMMARY

The settlement system of the first through third embodiments described above can have the following configurations.

(1) A settlement system having a settlement requesting device (community settlement requesting device 100) that has a processor (arithmetic device 102) and a memory (101); a settlement execution device (community settlement execution device 200) that has a processor (arithmetic device 202) and a memory (201); and an electronic credit management device (electronic credit management system 300) that manages electronic credits or debts, in which the settlement requesting device (100) issues a payment request in accordance with an electronic settlement medium (token), and the settlement execution device (200) accepts the payment request in accordance with the settlement medium (token), causes the electronic credit management device (300) to record the occurrence of a debt in accordance with the payment request, and transmits the settlement medium to a receiver (504).

According to the configuration described above, it is possible to realize settlement after the community settlement execution device 200 (settlement execution device) guarantees the value of a token (an electronic settlement medium) in the electronic credit management system 300, even with a community in which there is a company (operator) that does not participate in the electronic credit management system 300.

(2) The settlement system according to (1) described above, in which the settlement execution device (200), by causing the electronic credit management device (300) to record a debt for a value corresponding to the settlement medium (token), guarantees the value of the settlement medium.

According to the configuration described above, the community settlement execution device 200 (settlement execution device), by causing the debt that has occurred for the token (settlement medium) to be linked to the electronic credit management system 300, can guarantee the value of the token (settlement medium) by associating the token (settlement medium) with legal tender.

(3) The settlement system according to (1) described above, in which the settlement execution device (200), in a case where the receiver cannot use the electronic credit management device (300), transmits the settlement medium (token) to the receiver after assigning a guarantee by an operator (financial institution) of the settlement execution device (200).

According to the configuration described above, even in the case where the receiver 504 of the token cannot use the electronic credit management system 300, circulation of the token becomes possible by the financial institution (operator) that operates the community settlement execution device 200 assigning a guarantee.

(4) The settlement system according to (3) described above, in which the settlement execution device (200), in a case where the receiver cannot use the electronic credit management device (300), performs a discount by the settlement execution device (200) and sets a remainder for the discount to the value of the settlement medium (token) for the receiver.

According to the configuration described above, even in the case where the receiver 504 of the token cannot use the electronic credit management system 300, by the financial institution (operator) of the community settlement execution device 200 (settlement execution device) that has accepted the payment request performing a discount and making the remainder of subtracting a discount amount from the payment amount be a token for the receiver 504, the financial institution can receive consideration for risk.

(5) The settlement system according to (1) described above, in which the settlement requesting device (100) issues a liquidation request for the settlement medium (token), and the settlement execution device (200) accepts the liquidation request, determines whether an operator of the settlement requesting device (100) that has applied for the liquidation request can use the electronic credit management device (300), and, in a case where the operator cannot use the electronic credit management device (300), sets an operator of the settlement execution device (200) that has accepted the liquidation request as a guarantor, and makes a notification to the issuer of the settlement medium (token).

According to the configuration described above, it is possible to liquidate a token and make a deposit to an account of an applicant, irrespective of whether or not the receiver 504 or the payer 503 have a usage contract for the electronic credit management system 300.

(6) The settlement system according to (1) described above, in which the settlement requesting device (100) and the settlement execution device (200) share a distributed ledger (distributed token ledger 500) that records delivery and acceptance of the settlement medium (token), and the settlement requesting device (100) notifies the settlement execution device (200) of the payment request by writing the payment request to the distributed ledger (500).

According to the configuration described above, it is possible to cause circulation of a token (settlement medium) to be reflected to the electronic credit management system 300 via the distributed token ledger 500, and manage the occurrence, assignment, division, and erasure of a debt.

Note that the present invention is no limited to the embodiments described above, and includes various modifications. For example, the embodiments described above are set forth in detail in order to describe the present invention in a way that is easy to understand, and there is not necessarily a limitation to something provided with all of the configurations described. In addition, it is possible to replace a portion of the configuration of one embodiment with the configuration of another embodiment, and it is also possible to add, to the configuration of one embodiment, the configuration of another embodiment. In addition, it is also possible to apply, individually or in combination, any of the addition, deletion, or replacement of another configuration to a portion of the configuration of each embodiment.

In addition, a portion or the entirety of each configuration, function, processing unit, processing means, and the like described above, for example, may be designed in an integrated circuit to thereby be realized by hardware. In addition, each configuration, function, and the like describe above may be realized by software in accordance with a processor interpreting and executing a program that realizes respective functionality. Information such as programs, tables, and files for realizing respective functionality can be stored in a recording device such as a memory, a hard disk, or an SSD (Solid State Drive), or placed in a recording medium such as an IC card, an SD card, or a DVD.

In addition, control lines or information lines considered to be necessary for the description are illustrated, and it is not necessarily the case that all control lines or information lines for a product are illustrated. It may be considered that in practice almost all configurations are mutually connected.

1. A settlement system, comprising:
a settlement requesting device that has a processor and a memory;
a settlement execution device that has a processor and a memory; and
an electronic credit management device that manages electronic credits or debts, wherein
the settlement requesting device
issues a payment request in accordance with an electronic settlement medium, and
the settlement execution device
accepts the payment request in accordance with the settlement medium, causes the electronic credit management device to record the occurrence of a debt in accordance with the payment request, and transmits the settlement medium to a receiver.

2. The settlement system according to claim 1, wherein
the settlement execution device
by causing the electronic credit management device to record a debt for a value corresponding to the settlement medium, guarantees a value of the settlement medium.

3. The settlement system according to claim 1, wherein
the settlement execution device
in a case where the receiver cannot use the electronic credit management device, transmits the settlement medium to the receiver after assigning a guarantee by an operator of the settlement execution device.

4. The settlement system according to claim 3, wherein
the settlement execution device
in the case where the receiver cannot use the electronic credit management device, performs a discount by the settlement execution device and sets a remainder for the discount to a value of the settlement medium for the receiver.

5. The settlement system according to claim 1, wherein
the settlement requesting device
issues a liquidation request for the settlement medium, and
the settlement execution device
accepts the liquidation request, determines whether an operator of the settlement requesting device that has applied for the liquidation request, can use the electronic credit management device, and, in a case where the operator cannot use the electronic credit management device, sets an operator of the settlement execution device that has accepted the liquidation request as a guarantor, and makes a notification to an issuer of the settlement medium.

6. The settlement system according to claim 1, wherein
the settlement requesting device and the settlement execution device share a distributed ledger that records delivery and acceptance of the settlement medium, and the settlement requesting device notifies the settlement execution device of the payment request by writing the payment request to the distributed ledger.

7. A settlement method of executing settlement among a settlement requesting device that has a processor and a memory, a settlement execution device that has a processor and a memory, and an electronic credit management device that manages electronic credit or debt, the settlement method comprising:
a payment request issuance step in which the settlement requesting device issues a payment request in accordance with an electronic settlement medium;
a debt recording step in which the settlement execution device accepts the payment request in accordance with the settlement medium, and records occurrence of a debt in accordance with the payment request in the electronic credit management device; and
a transmission step in which the settlement execution device transmits the settlement medium to a receiver included in the payment request.

8. The settlement method according to claim 7, wherein
in the debt recording step,
by causing the electronic credit management device to record a debt for a value corresponding to the settlement medium, a value of the settlement medium is guaranteed.

9. The settlement method according to claim 7, wherein
in the transmission step,
in a case where the receiver cannot use the electronic credit management device, the settlement medium is transmitted to the receiver after assigning a guarantee by an operator of the settlement execution device.

10. The settlement method according to claim 9, wherein
in the transmission step,
a discount is performed by the settlement execution device, and a remainder for the discount is set to a value of the settlement medium for the receiver.

11. The settlement method according to claim 7, further comprising:
a liquidation request issuance step in which the settlement requesting device issues a liquidation request for the settlement medium; and
a liquidation request acceptance step in which the settlement execution device accepts the liquidation request, determines whether an operator of the settlement requesting device that has applied for the liquidation request, can use the electronic credit management device, and, in a case where the operator cannot use the electronic credit management device, sets an operator of the settlement execution device that has accepted the liquidation request, as a guarantor, and makes a notification to an issuer of the settlement medium.

12. The settlement method according to claim 7, wherein
the settlement requesting device and the settlement execution device share a distributed ledger that records delivery and acceptance of the settlement medium, and
in the payment request issuance step,
the settlement requesting device notifies the settlement execution device of the payment request by writing the payment request to the distributed ledger.
